(19) United States
(12) Patent Application Publication
(10) Pub. No.: US 2006/0124750 A1
(43) Pub. Date: Jun. 15, 2006

(54) Data carrier and production method

(75) Inventor: Harald Reiner, Muenchen (DE)

Correspondence Address: ROTHWELL, FIGG, ERNST & MANBECK, P.C., 1425 K STREET, N.W., SUITE 800, WASHINGTON, DC, 20005, US

(73) Assignee: Giesecke & Devrient GmbH, Muenchen (DE)

(21) Appl. No.: 10/559,277

(22) PCT Filed: Jun. 1, 2004
(86) PCT No.: PCT/EP04/05903

§ 371 Date: Dec. 2, 2005

(30) Foreign Application Priority Data
Jun. 5, 2003 (DE) 103 25 604.0

(51) Int. Cl. G06K 19/06

(52) U.S. Cl. 235/492

(57) ABSTRACT

The invention relates to a data carrier with an areal, flexible substrate (12), which at least has one deep embossing (20), wherein an integrated circuit component (14) is disposed. The invention also relates to methods for producing such a data carrier.

### CROSS-REFERENCE TO RELATED APPLICATION

This application is a National Phase of International Application Serial No. PCT/EP2004/005903, filed Jun. 1, 2004.

### BACKGROUND OF INVENTION

1. Field of the Invention

The invention relates to a data carrier with an areal, flexible substrate, a production method for such a data carrier and the use of such a data carrier.

2. Description of the Background Art

Data carriers within the meaning of the present invention in particular are security documents or documents of value, such as bank notes, passports, identification documents, check forms, share certificates, deeds, stamps, vouchers, flight tickets and the like, as well as labels, seals, packagings and other elements for the product protection. The term “data carrier” in the following includes all such documents and means for product protection.

The said documents have in common, that their market value or utility value by far exceeds their material value. Therefore, such documents normally are put through elaborate processes, so as to render the documents to be distinguishable from imitations or forgeries. For this purpose they are provided with security elements, which are difficult to imitate and permit the authenticity check of the security element being made by a layman. For example, printed areas produced by intaglio printing are characterized by a typical tactility that is easy to recognize even for the layman, which cannot be reproduced by other printing methods, and in particular not by copying machines or scanners.

There have been made some proposals to improve the forgery-proofness of documents of value, such as for instance bank notes, by means of incorporated or applied integrated circuits. As described, for example, in the print DE 196 01 358 A1, in such a microchip the money value and the register number of a bank note can be stored.

The information stored in the microchip can be read out quickly and contactlessly with a respective reading device. By this means in addition to effecting the authenticity testing, bank notes can also be invisibly marked, so as to later be able, for example, to easily identify blackmailer money.

However, it has turned out that the tactile contours also constitute a weak point as to manipulations, since the microchip in the bank note can be found immediately. The spatial structure of the contour also leads to problems with respect to the desired easy stackability and the automatic processing of bank notes. Moreover, the area of the bank note provided with the microchip is subject to an increased abrasion during the daily circulation, which locally leads to increased mechanical signs of wear and even to the chip being detached.

### SUMMARY OF THE INVENTION

On these premises the invention is based on the problem to create a data carrier that is improved compared to the prior art, wherein in particular an incorporated microchip is protected against easy detection and against mechanical stress.

This problem is solved by the data carrier having the features of the main claim. A method for producing such a data carrier as well as the use of such a data carrier are subject matter of the independent claims. Developments of the invention are subject matter of the subclaims.

According to the invention the substrate of a data carrier of the above-mentioned kind has at least one deep embossing, in which a circuit component is disposed. By this means the circuit component is protected against mechanical stress and is substantially less striking with respect to optical impression and tactility.

The deep embossing of the substrate is produced by intaglio printing. In particular, advantageously a high-resolution steel intaglio engraving technique according to the EP 0 906 193 A1 can be used, wherein intaglio printing plates by means of electronically controlled graver are milled, so that very fine and extremely accurate engravings of the printing plate are possible.

In an advantageous embodiment of the data carrier the deep embossing is embossed without covering the printing plate with ink, i.e., it is blind-embossed. By this means especially great structure depths can be achieved in the flexible substrate.

The circuit component expediently is adhesively bonded into the deep embossing. Here both a non-conductive and a conductive adhesive can be used. When the circuit component is brought into contact with the conductive surfaces of an antenna structure or the like by means of flip chip mounting, for fixing and simultaneously electrically contacting the component according to a preferred embodiment an anisotropically conductive adhesive, ACA or an anisotropically conductive film, ACF is used. These are adhesives with an insulating matrix, which is filled with electrically conductive particles. Due to its low particle density the adhesive in its ground state is not conductive. Only by the adhesive being clamped between two conductive surfaces an electrical conductivity in the direction of the connecting line of the conductive surfaces is produced.

The lateral dimension and the depth of the deep embossing expediently are adjusted to the size of the circuit component, so as to permit the accommodation of the circuit component. Here it is of advantage, when the deep embossing is produced with a lateral dimension that is only slightly larger than the circuit component. For example, the lateral dimensions of the deep embossing can be selected 3% to 10% larger than the dimensions of the circuit component.

The depth of the embossing preferably is larger than the height of the circuit component, so that the circuit component is fully accommodated by the recess of the embossing. However, a small projecting end of the circuit component can be evened out by further applied layers, such as for example a covering element or a lacquer layer. In both cases the component is not tactilely detectable. In other embodiments a certain projecting of the end of the circuit component can be accepted without causing problems, since the surface of the data carrier due to the embossing anyway has a tactilely detectable structure, in which the small projecting end of the integrated circuit component is not striking.

The lateral dimensions of the circuit component can range, for example, between 0.2 millimeter×0.2 millimeter and 1 millimeter×1 millimeter. Microchips with a thickness of about 200 micron or less are already widely used today. According to an advantageous variant the thickness of the components amounts only to a fractional part of the thickness of the flexible substrate. For paper substrates having a typical thickness of 70 to 100 micron expediently circuit components with a thickness of about 15 to about 60 micron are used.

For a simpler handling and contacting instead of mere semiconductor components advantageously chip modules are used, wherein the circuit component is mounted on a carrier. Such modules can be brought into electrical contact with an antenna structure in a simple fashion. The total thickness of such a module currently amounts to about 220 micron or less. In the area of the intaglio printing, for example, areal, three-dimensionally tactile and embossed structures can be realized, the structure depth of which when blind-embossed amounts to up to about 200 micron, and which thus can accommodate the said chip modules without problems.

According to a preferred development of the invention the substrate has a plurality of deep embossings of the same kind, the circuit component being disposed in one of the embossings of the same kind. By this means the place of incorporation of the integrated circuit component can vary, so that a localizing and thus a manipulation of the component is made more difficult. If the deep embossings are distributed over a certain area, for example some square centimeter, or even largely over the whole surface of the data carrier substrate, despite the deep embossings there can be achieved practical unchanged good flatness and stackability of the data carrier. A good stackability is essential in particular for documents of value, such as for instance bank notes.

As to further hide the presence and the position of the circuit component, the deep embossing or the plurality of deep embossings of the same kind according to an advantageous development of the invention form part of a picture motif, such as a portrait, a landscape motif, a animal motif, an architectural representation or the like. Such picture motifs are applied to many documents of value anyway, so that the user does not readily notice that the deep embossing is additionally used as a receptacle for a microchip.

According to an advantageous embodiment the areal substrate of the data carrier has a front and a back, the recess of the embossing with the circuit component disposed therein being disposed on the substrate back. The deep embossing on the substrate back expediently is closed by an opaque covering element. In particular, the covering element may comprise a metallic optical security element, such as a metallic embossed hologram, for instance in the form of a stripe or a label, or an opaque lacquer layer. The circuit component is both protected and hidden by the covering element. As covering elements beside the already mentioned examples also all kinds of transfer elements are suitable, such as described for example in the print WO 02/02350.

In an expedient embodiment the covering element is electrically conductive and forms a coupling element for the contactless communication between the integrated circuit component and a read/write device. It can be, for example, a capacitive antenna surface or a coil for an inductive coupling.

According to another preferred embodiment of the data carrier according to the invention the substrate front in the area of the deep embossing is provided with a conductive surface, which forms a coupling element for the contactless communication between the integrated circuit component and a read/write device. In particular, the conductive surface can have the form of a stripe, a label, or a medal. Expediently, it is printed onto the areal data carrier substrate, for example with conductive silver ink by means of screen printing.

In an advantageous development of the invention form and dimension of the conductive surface and of the covering element are adjusted to each other, so as to produce a through optical impression. For example, when the conductive surface has the form of a medal, the covering element can be designed as a medal of the same size and disposed in exact register with the conductive surface on the back, so that by the two elements together a through medal effect is achieved.

Preferably, the conductive surface is provided with a visually and/or automatically testable optical effect, which increases the forgery-proofness of the data carrier.

The coupling element, which can be formed by a conductive surface on the substrate front or by a conductive covering element, preferably represents a folded dipole, a coil or an open dipole.

According to an advantageous development of the invention on the back of the data carrier substrate is applied an antenna structure. Preferably, the antenna structure is printed onto the substrate, for example with conductive silver ink by means of screen printing. The antenna structure advantageously is integrated in a graphic picture motif on the substrate back, so as to render the presence of an antenna less obvious and to achieve an attractive graphic total design. The graphic picture motif, for example, can be produced by offset printing or flexographic printing.

In the deep embossing preferably conductive surfaces for electrically connecting the circuit component with the antenna structure are provided. With the help of these conductive surfaces the circuit component can be brought into electrical contact for example by flip chip mounting. In particular, the circuit component can be adhesively bonded into the deep embossing with an anisotropically conductive adhesive (ACA) or via an anisotropically conductive film (ACF) and at the same time an electrical contact with the conductive surfaces of the deep embossing can be established.

Alternatively, on the circuit component are applied conductive surfaces for electrically connecting the circuit component with the antenna structure. Since in this variant the component is already incorporated into the deep embossing when applying the conductive surfaces, it has to be taken into account that the mechanical stress acting on the circuit component and the deep embossing is to be kept as low as possible. This can be achieved, for example, by printing the conductive surfaces by means of the screen printing process.

According to an advantageous embodiment the form of the antenna structure is adjusted to the arrangement of the plurality of deep embossings of the same kind, so that the circuit component can be brought into contact with the antenna structure in each of the plurality of deep embossings. For example, a plurality of antenna structures of the same kind can be provided, the conductive surfaces of which each ending in one of the deep embossings.

According to another variant one single antenna structure is provided, which can be contacted by the circuit component at a plurality of points. For this purpose, for example, a conductor loop can be provided, the initial piece and end piece of which along a certain contact path run at a small distance in parallel to each other, so that the circuit component can be built in at every point along this contact path in such a way, that it electrically contacts the initial piece and end piece of the antenna.

The areal substrate expediently at least in a partial area comprising the deep embossing is stiffened with a lacquer layer. The lacquer layer at the same time protects the tactile structures against abrasion and damage.

In advantageous embodiments of the data carrier according to the invention the substrate is formed of cotton paper or of paper with a mixture of cotton/synthetic fiber.

The circuit component in particular is a memory chip or a microprocessor chip.

A method for producing a data carrier of the described type comprises the following steps:

a) providing an areal, flexible data carrier substrate with a front and a back,

b) providing a circuit component of a predetermined size,

c) blind-embossing the substrate front for producing at least one deep embossing on the substrate back, the lateral dimension and depth of which are adjusted to the predetermined size of the circuit component, so as to permit the accommodation of the circuit component, and

d) incorporating the circuit component into the deep embossing.

The blind-embossing in step c) is carried out with the help of an intaglio printing technique. Before the blind-embossing, in an advantageous method variant, a conductive surface is applied onto the substrate front, preferably by means of the screen printing process.

The circuit component in step d) expediently is adhesively bonded into the deep embossing, preferably with an anisotropically conductive adhesive (ACA) or via an anisotropically conductive film (ACF).

Onto the substrate back advantageously an antenna structure is applied, preferably it is printed by means of the screen printing process with conductive silver ink. Additionally, onto the substrate back a graphic picture motif can be printed, preferably by offset printing or flexographic printing method, into which the antenna structure is integrated. Expediently, the antenna structure is applied onto the substrate back before the blind-embossing.

After having incorporated the circuit component, the deep embossing in a step e) advantageously is closed with an opaque covering element. As a covering element a foil application can be applied onto the substrate back, preferably with the help of a low-melting heat-sealing adhesive. In the end onto the substrate advantageously at least in the area of the deep embossing a lacquer layer is applied.

On the whole, a circuit component is incorporated into a data carrier, without an additional tactile or optically striking thickening being connected therewith.

The data carrier according to the invention beside its described main use in the form of a document of value, such as a bank note, can also be used as a means for product protection for protecting goods of any kind.

### BRIEF DESCRIPTION OF THE DRAWINGS

Further embodiments as well as advantages of the invention are explained in the following with reference to the Figures. For clarity's sake the figures do without a true-to-scale and true-to-proportion representation.

FIG. 1 shows a schematic representation of a bank note with incorporated chip module according to an embodiment of the invention,

FIG. 2 shows a section through the bank note shown in FIG. 1 in schematic representation,

FIG. 3 shows a schematic representation of a bank note according to another embodiment of the invention, and

FIG. 4 in (a) and (b) shows a front view and a back view of a bank note according to a further embodiment of the invention.

### DETAILED DESCRIPTION OF THE INVENTION

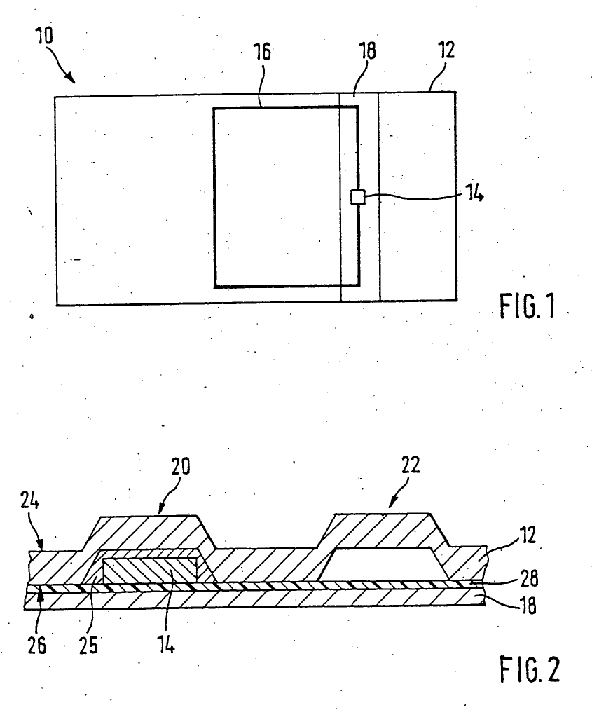

The invention in the following is explained with reference to a bank note. FIG. 1 schematically shows a bank note 10 with a paper substrate 12, into which a chip or chip module 14 is incorporated. The contactless communication between the chip or chip module 14 and a not shown read/write device is effected via an antenna structure 16. The possible designs of the antenna structure, for instance as an open dipole or as a folded dipole, are known for example from the field of the transponder chips and therefore they are not described in detail here.

The size of the chip module 14 in the FIG. 1 for clarity's sake is represented in an excessive fashion. The circuit component in the embodiment has a dimension of 1 millimeter×1 millimeter×150 micron. The whole chip module with the metallic carrier e.g. has a thickness of about 220 micron.

As to be recognized best in the cross-sectional view of FIG. 2, the chip module 14 is disposed in a deep embossing 20 of the substrate 12, the deep embossing being produced by blind-embossing within the framework of an intaglio printing process. The depth of the embossing 20 amounts to about 220 micron, so that the chip module 14 to a large extent completely is accommodated by the embossing 20. Beside the deep embossing 20 a series of embossings 22 of the same kind is distributed over the substrate surface. By means of the plurality of embossings 22 the flatness and the stackability of the bank notes 10 can be kept within the hitherto usual scope.

For manufacturing the shown bank note, onto the front 24 of the substrate 12 a conductive surface is applied with silver ink by means of screen printing, the conductive surface not being shown in the FIGS. 1 and 2. The conductive surface can have for example the form of a medal, as described later in connection with the FIG. 4(a).

Onto the back 26 of the substrate 12 is printed the antenna structure 16, in this embodiment, too, with silver ink by means of the screen printing technique. The antenna is embedded into a not shown graphic total design on the substrate back, which can be produced by offset printing or flexographic printing. Together with the antenna structure 16 conductive surfaces are printed, which extend into the area of the deep embossing 20 that is subsequently produced.

Then by means of blind-embossing within the framework of the intaglio printing process structures 20, 22 are embossed into the front 24 of the substrate, which permit the accommodation of the chip module 14 as to both their lateral and their vertical dimension. Then the chip module 14 is positioned in the embossing 20 and adhesively bonded to it. The positioning can be effected with specifically adapted, so-called “pick-and-place” machines, such as offered for example by the manufacturers Müthlbauer, Simotec or Datacon. In the embodiment the chip module 14 is fixed in the embossing 20 by means of an anisotropically conductive adhesive 25 and at the same time electrically connected to the conductive surfaces of the antenna structure 16 extending into the embossing.

In a further step by means of a low-melting heat-sealing adhesive 28, while avoiding mechanical stress on the chip module 14 and on the embossed structure 20, 22, a foil application 18 is applied as a covering element onto the substrate back 26. In the embodiment of the FIGS. 1 and 2 the foil application 18 is formed by a metallic stripe having an embossed hologram. It is obvious, that the covering element only has to be designed to be conductive and has to fulfill the function of a coupling element when this function is not assumed or insufficiently assumed by the conductive surface of the substrate front 26.

Finally, a lacquer layer is applied onto the bank note 10, which stiffens the bank note 10 and protects the tactile structures 20, 22 against abrasion and damage.

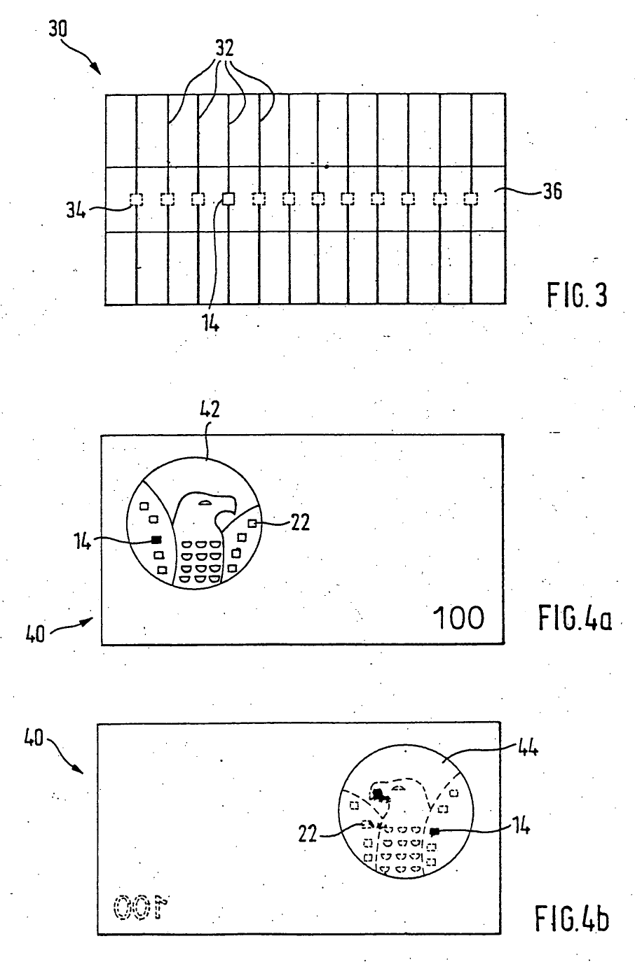

FIG. 3 shows a further bank note 30 according to the invention having an antenna structure 32, which allows the incorporation of the integrated circuit component 14 at one of a plurality of equivalent incorporation positions 34. All incorporation positions 34 are provided with a deep embossing 22, and after the circuit component 14 being incorporated, they are closed with one joint opaque covering element 36.

A bank note 40 having a through medal effect is shown in the FIG. 4. FIG. 4(a) shows the front, FIG. 4(b) the back of the bank note. The conductive layer 42 of the front in this embodiment has the form of a medal with an animal motif (eagle).

The plumage of the eagle has a plurality of deep embossings 22 of the same kind, which all may serve for accommodating the integrated circuit component 14. In one of the deep embossings 22 the integrated circuit component 14 is incorporated. The position of the embossing 22, which accommodates the integrated circuit component 14, may vary for the different bank notes or for the different series.

On the back of the bank note a metallic covering element 44 is disposed congruently with the conductive layer 42 of the front, so that the cooperation of conductive layer 42 and metallic covering element 44 results in an optically attractive, through medal effect.

1. A data carrier with an areal, flexible substrate, which has at least one deep embossing, wherein an electronic circuit component is disposed, characterized in that the deep embossing is produced by intaglio printing, in particular by a high-resolution engraving technique in steel intaglio.

2. The data carrier according to claim 1, characterized in that the deep embossing is blind-embossed.

3. The data carrier according to claim 1, characterized in that the circuit component is adhesively bonded into the deep embossing.

4. The data carrier according to claim 1, characterized in that the lateral dimension and the depth of the deep embossing are adjusted to the size of the circuit component, so as to permit the accommodation of the circuit component.

5. The data carrier according to claim 1, characterized in that the substrate has a plurality of deep embossings of the same kind, and the circuit component is disposed in one of the embossings of the same kind.

6. The data carrier according to claim 1, characterized in that the deep embossing or the plurality of deep embossings of the same kind form part of a picture motif, such as a portrait, a landscape motif, an animal motif, an architectural representation or the like.

7. The data carrier according to claim 5, characterized in that the areal substrate has a front and a back, wherein the recess of the embossing with the circuit component is disposed on the substrate back.

8. The data carrier according to claim 7, characterized in that the deep embossing on the substrate back is closed by an opaque covering element.

9. The data carrier according to claim 8, characterized in that the covering element comprises a metallic optical security element.

10. The data carrier according to claim 8, characterized in that the covering element comprises an opaque lacquer layer.

11. The data carrier according to claim 8, characterized in that the covering element is electrically conductive and forms a coupling element for the contactless communication between the circuit component and a read/write device.

12. The data carrier according to claim 7, characterized in that the substrate front in the area of the deep embossing is provided with a conductive surface, which forms a coupling element for the contactless communication between the circuit component and a read/write device.

13. The data carrier according to claim 12, characterized in that the conductive surface has the form of a stripe, label, or medal.

14. The data carrier according to claim 8, characterized in that form and dimension of the conductive surface and of the covering element are adjusted to each other, so as to produce a through optical impression.

15. The data carrier according to claim 12, characterized in that the conductive surface is provided with at least one of a visually testable or automatically testable optical effect.

16. The data carrier according to claim 11, characterized in that the coupling element forms a folded dipole, a coil, or an open dipole.

17. The data carrier according to claim 7, characterized in that onto the substrate back is applied an antenna structure.

18. The data carrier according to claim 17, characterized in that the antenna structure is integrated in a graphic picture motif.

19. The data carrier according to claim 17, characterized in that in the deep embossing are provided conductive surfaces for electrically connecting the circuit component to the antenna structure, and that the circuit component is brought into electrical contact with the conductive surfaces of the deep embossing by flip chip mounting.

20. The data carrier according to claim 19, characterized in that the circuit component is adhesively bonded into in the deep embossing with an anisotropically conductive adhesive or via an anisotropically conductive film and therewith is brought into electrical contact with the conductive surfaces of the deep embossing.

21. The data carrier according to claim 17, characterized in that onto the circuit component are applied conductive surfaces for electrically connecting the circuit component to the antenna structure.

22. The data carrier according to claim 17, characterized in that the form of the antenna structure is adjusted to the arrangement of the plurality of deep embossings of the same kind, so that the circuit component can be brought into contact with the antenna structure in each of the plurality of deep embossings.

23. The data carrier according to claim 1, characterized in that the areal substrate at least in a partial area comprising the deep embossing is stiffened with a lacquer layer.

24. The data carrier according to claim 1, characterized in that the substrate is formed of cotton paper or of paper with a mixture of cotton/synthetic fiber.

25. The data carrier according to claim 1, characterized in that the circuit component is at least one of a memory chip, a microprocessor chip or contains components, which are suitable for processing analog signals.

26. The data carrier according to claim 1, characterized in that the circuit component contains a luminescence diode or an OLED.

27. A method for producing a data carrier according to claim 1, characterized by the following steps:
a) providing an areal, flexible data carrier substrate with a front and a back,
b) providing an integrated circuit component of a predetermined size,
c) blind-embossing the substrate front for producing at least one deep embossing on the substrate back, the lateral dimension and depth of which are adjusted to the predetermined size of the integrated circuit component, so as to permit the accommodation of the integrated circuit component, and
d) placing the integrated circuit component into the deep embossing, characterized in that the blind-embossing in step c) is carried out with an intaglio printing technique.

28. The method according to claim 27, characterized in that before the blind-embossing in step c) a conductive surface is applied onto the substrate front.

29. The method according to claim 27, characterized in that the integrated circuit component in step d) is adhesively bonded the deep embossing.

30. The method according to claim 27, characterized in that an antenna structure is applied onto the substrate back.

31. The method according to claim 30, characterized in that onto the substrate back a graphic picture motif is printed.

32. The method according to claim 30, characterized in that the antenna structure is applied onto the substrate back before the step of the blind-embossing.

33. The method according to claim 27, characterized in that in a step e) the deep embossing is closed with an opaque covering element.

34. The method according to claim 33, characterized in that as a covering element a foil application is applied onto the substrate back.

35. The method according to claim 27, characterized in that onto the substrate at least in the area of the deep embossing a lacquer layer is applied.

36. A method of protecting goods comprising utilizing with said goods a data carrier according to claim 1.

37. (canceled)

38. (canceled)

39. (canceled)

40. The data carrier of claim 1 wherein said circuit is an integrated circuit.

41. The data carrier of claim 9 wherein said metallic optical security element comprises a metallic embossed hologram.

42. The data carrier of claim 14 wherein said through optical impression is a through medal effect.

43. The data carrier of claim 17 wherein the antenna structure is printed onto the substrate back.

44. The data carrier of claim 21 wherein the conductive surfaces are printed onto the circuit component.

45. The method of claim 27 wherein said printing technique is a high-resolution engraving technique.

46. The method of claim 28 wherein the conductive surface is printed by a screen printing process.

47. The method of claim 29 wherein the deep embossing is adhesively bonded with an anisotropically conductive adhesive (ACA) or via an anisotropically conductive film (ACF).

48. The method of claim 30 wherein the antenna structure is printed by a screen printing process.

49. The method of claim 31 wherein the graphic picture motif is printed by an offset printing or flexographic printing process, into which is integrated the antenna structure.

50. The method of claim 34 wherein the foil application is applied by a low-melting heat-sealing adhesive.

51. A method of protecting goods comprising utilizing with said goods a data carrier produced according to the method of claim 27.
